(19) United States
(12) Patent Application Publication
(10) Pub. No.: US 2014/0266073 A1
(43) Pub. Date: Sep. 18, 2014

(54) ENERGY STORAGE CIRCUIT

(71) Applicant: Silver Spring Networks, Redwood City, CA (US)

(72) Inventor: Richard Keller, Redwood City, CA (US)

(21) Appl. No.: 13/844,209

(22) Filed: Mar. 15, 2013

(51) Int. Cl. H02J 9/00

(52) U.S. Cl. CPC H02J 9/00
USPC 320/166

(57) ABSTRACT

An energy storage (ES) circuit, including: a plurality of terminals configured to: connect to a pulse load having an input voltage and drawing a low current during a first interval and a high current during a second interval; and connect to a power supply having a source voltage and delivering a source current; an energy storage capacitor connected to the plurality of terminals; and a bidirectional direct current (DC) to DC converter configured to: recharge, during at least a portion of the first interval, the energy storage capacitor using a plurality of charge drawn from the source current; and reduce a drop in the input voltage during the second interval by delivering a difference between the source current and the high current to the pulse load using the plurality of charge stored in the energy storage capacitor.

### BACKGROUND

Many electrical and electronic systems have current or power requirements that vary with time, often requiring a relatively high current for a short period of time. For example, digital integrated circuits require a high pulse current during clock cycle edges to power logic circuits that are changing state. High pulse currents are difficult to source from power supplies due to power supply current limitations and/or unacceptable voltage drops across the transmission lines connecting the power supply and the (i.e., load).

### SUMMARY

In general, in one aspect, the invention relates to an energy storage (ES) circuit. The ES circuit comprises: a plurality of terminals configured to: connect to a pulse load having an input voltage and drawing a low current during a first interval and a high current during a second interval; and connect to a power supply having a source voltage and delivering a source current; an energy storage capacitor operatively connected to the plurality of terminals; and a bidirectional direct current (DC) to DC converter configured to: recharge, during at least a portion of the first interval, the energy storage capacitor using a plurality of charge drawn from the source current; and reduce a drop in the input voltage during the second interval by delivering a difference between the source current and the high current to the pulse load using the plurality of charge stored in the energy storage capacitor.

In general, in one aspect, the invention relates to a method for operating an energy storage (ES) circuit comprising an energy storage capacitor and a plurality of terminals. The method comprises: drawing, by the ES circuit, a plurality of charge from a source current delivered by a power supply having a source voltage, wherein the plurality of terminals connect to the power supply and to a pulse load having an input voltage and drawing a low current during a first interval and a high current during a second interval; recharging, during at least a portion of the first interval and by a bidirectional direct current (DC) to DC converter of the ES circuit, the energy storage capacitor using the plurality of charge; and reducing, by the ES circuit, a drop in the input voltage during the second interval by delivering a difference between the source current and the high current to the pulse load using the plurality of charge stored in the energy storage capacitor.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a graph detailing the operation of an energy storage circuit in accordance with one or more embodiments of the invention.

FIG. 3 shows an energy storage circuit in accordance with one or more embodiments of the invention.

FIG. 4 shows an energy storage circuit in accordance with one or more embodiments of the invention.

FIG. 5 shows an energy storage circuit in accordance with one or more embodiments of the invention.

FIG. 6 shows a flowchart of a method in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide an energy storage circuit for delivering current to a pulse load (i.e., a load that requires high currents for short intervals of time). Specifically, one or more embodiments of the invention provide a method and system for charging an energy storage capacitor from the power supply when the pulse load requires a low current and delivering extra current from the energy storage capacitor to the pulse load when the pulse load requires a high current. A bidirectional DC-DC voltage converter is used to charge the energy storage capacitor to a voltage that is higher than the power supply source voltage, enabling the storage of more energy per capacitance and thus reducing the size requirements of the energy storage capacitor.

FIG. 1 shows a diagram of a system (100) in accordance with one or more embodiments of the invention. The system (100) includes a power supply (110) that is connected to a pulse load (140) via one or more transmission lines. The transmission line(s) include distribution impedance (120). The power supply (110) generates a source voltage (112) and a source current (114) that flows through the distribution impedance (120) and into the pulse load (140) having an input voltage (142). An energy storage circuit (130) is connected to the pulse load (140) via terminals (i.e., Terminal A (132) and Terminal B (134)). Each of these components is further described below.

In one or more embodiments of the invention, the power supply (110) is configured to provide power to the pulse load (140). The power supply (110) may be implemented using any combination of an external voltage sources (e.g., generators), one or more batteries, one or more voltage regulators, converters, transformers, wall sockets/power outlets, electrical components, and any other components. The power supply (110) includes two or more terminals over which a source voltage (112) is provided. The source current (114) will flow from a positive terminal of the power supply to a negative terminal of the power supply when a closed circuit (e.g., a connection across a load) is made between the terminals of the power supply (110).

In one or more embodiments of the invention, there exists a relationship between the source voltage (112) and the source current (114) of the power supply (110). The relationship may be referred to as the power supply attributes (198). For example, the power supply (110) may provide a source voltage (112) that is constant or nearly constant (e.g., varies by less than 1%) for values of source current (114) from 0 A to a current limit (197) (e.g., 1 A). The current limit (197) may be due to a finite source resistance of the power supply (110) or any other limitation of power supplies. For values of source current (114) exceeding the current limit (197), the source voltage (112) may drop significantly. Such a drop in source voltage (112) may also cause a drop in the input voltage (142) of the pulse load (140), causing undesirable behavior of the pulse load (140) and/or damage to the pulse load (140).

In one or more embodiments of the invention, the distribution impedance (120) is an impedance associated with the transmission line(s) connecting the terminals of the power supply (110) and the terminals of the pulse load (140). The distribution impedance (120) may be due to the finite resistance and inductance of interconnect wires, printed circuit board (PCB) routes, wire bonds, solder balls, electrical components, and any other means of connecting the power supply (110) to the pulse load (140). Those skilled in the art, having the benefit of this detailed description, will appreciate that when source current (114) flows through the distribution impedance (120), there may be a voltage drop across the distributed impedance (120). Increasing the source current (114) magnifies the voltage drop. As a result, the input voltage (142) is less than the source voltage (112). Accordingly, as the source current (114) increases (e.g., to satisfy the high pulse current demands of the pulse load (140)), the input voltage (142) may drop due to (i) the decrease in the source voltage (112) of the power supply (110) reaching/passing the current limit (197); and/or (ii) the larger voltage drop across the distribution impedance (120).

In one or more embodiments of the invention, the pulse load (140) is any electrical or electronic system that requires or dissipates electrical power or electrical current at a rate that varies with time. The pulse load (140) may be a switch, a transistor, a microchip, a transformer, a radio, a transceiver, or any other system that has varying current requirements.

In one or more embodiments of the invention, there exists a relationship between the input current (144) of the pulse load (140) and time. This relationship may be referred to as the pulse load attributes (199). As shown in FIG. 1, the pulse load (140) may require a low current (146) most of time and a high current (148) for short intervals. The average current (not shown) required by the pulse load (140) may be significantly smaller (e.g., 75% smaller) than the high current (148). For example, the pulse load (140) may be a digital microchip that requires large amounts of current during switching events but requires little current at other times. In addition to the varying current, the pulse load (140) may require a constant or nearly constant (e.g., varying by less than 10%) input voltage (142) at all times in order to operate properly. For example, a microchip that operates nominally at a 1 V input voltage may require less than a 0.1 V drop in the input voltage during a switching event in order to ensure all logical computations are completed before the next clock cycle. Those skilled in the art, having the benefit of this detailed description, will appreciate that the pulse load attributes (199) may include more than two current levels. Further, the pulse load attributes (199) may be periodic (i.e., the relationship between input current (144) and time repeats with a given period) or aperiodic (e.g., random).

In one or more embodiments of the invention, if the power supply (110) is the sole current source in the system (100), the power supply (110) needs to provide all of the high current (148). However, as discussed above, a higher source current (114) potentially leads to a lower source voltage (112) and/or a larger voltage drop across the distribution impedance (120), resulting in an undesirable drop in the input voltage (142).

In one or more embodiments of the invention, the system (100) includes an energy storage circuit (130). The energy storage circuit (130) is configured to reduce the drop of the input voltage (142) by providing additional current to the pulse load (140) when required (e.g., when the pulse load (140) is drawing the high current (148)). This reduces the current demand on the power source (110) and thus keeps the source current (114) from grossly exceeding the current limit (197). As the power supply (110) now delivers less current, the voltage drop across distributed impedance (120) is also less.

In one or more embodiments of the invention, the energy storage circuit (130) includes one capacitor or networked capacitors to store energy (i.e., charge). This stored charge is supplied to the pulse load (140) and supplements the source current (114) during a high current (148) time interval (i.e., pulse condition).

In one or more embodiments of the invention, when the source current (114) is more than sufficient to meet the demands of the pulse load (e.g., when the pulse load (140) is drawing the low current (146)), the electrical charge stored in the capacitor(s) may be replenished by the power supply (110). In other words, the portion of source current (114) not being delivered to the pulse load (140) is used to charge the capacitors in the energy storage circuit (130).

In one or more embodiments of the invention, the energy storage circuit (130) has two terminals (i.e., terminal A (132) and terminal B (134)) that are connected to the terminals of the pulse load (140). The terminals (132, 134) are placed in close proximity to the pulse load (142) to reduce the impedance (not shown) in the transmission line(s) between the terminals (132,134) the pulse load (140). Moreover, the terminals (132, 134) are closer to the pulse load (140) than the power supply (110). Accordingly, the voltage across the terminals (132, 134) is approximately the input voltage (142).

FIG. 2 shows a graph in accordance with one or more embodiments of the invention. The graph in FIG. 2 details the operation of one or more of the components (110, 130, 140) in the system (100), discussed above in reference to FIG. 1. The x-axis of the graph corresponds to time and the y-axis of the graph corresponds to electrical current. The solid line represents the input current (144) delivered to the pulse load (140) over time. The dashed line represents the source current (114) from the power supply (110). The graph contains three distinct regions of operation; each region is further described below.

As discussed above, the pulse load (140) draws either high current (148) or low current (146). As shown in the graph of FIG. 2, the low current (146) is less than the source current (114). While the pulse load (140) is drawing the low current (146), the excess charge in the source current (114) is delivered to the energy storage circuit (130) for storage. The area between the source current (114) and the low current (146) represents the excess source current over time delivered to the energy storage circuit (130). The source current (114) may correspond to the current limit (197) or some current near the current limit (197).

In one or more embodiments of the invention, once the capacitor(s) in the energy storage circuit (130) are fully charged, the source current (114) from the power supply (110) may decrease to the level of the low current (146) or the excess source current may be delivered elsewhere (e.g., to another load).

In one or more embodiments of the invention, after another interval of time, a pulse condition exists and the pulse load (140) draws the high current (148). The high current (148) may be higher than the source current (114). The energy storage circuit (130) supplies the additional current. In other words, the current difference (i.e., high current−source current) is drawn from the energy storage circuit (130). The current drawn from the energy storage circuit (130) is represented by the area above the source current (114) and below the high current (148).

In one or more embodiments of the invention, the input current (144) again transitions to a low current (146) and again the power supply (110) begins to deliver excess source current to the energy storage circuit (130). The pulse condition may occur again at some point after this time interval.

FIG. 3 shows a circuit diagram of the energy storage circuit (130) in accordance with one or more embodiments of the invention. The energy storage circuit (130) includes a voltage regulation interface (VRI) circuit (310), a bidirectional DC-DC converter (320), and an energy storage capacitor (ESC) (330). Those skilled in the art will appreciate that the circuit diagram of FIG. 3 is one possible embodiment of the energy storage circuit (130) and some of the components of the energy storage circuit (130) can be removed, rearranged, replaced, and modified, while other components may be added. Each of these components is further described below.

In one or more embodiments of the invention, the energy storage capacitor (330) is a single capacitor (e.g., a ceramic capacitor, an electrolytic capacitor, a film capacitor, a double-layer capacitor, a pseudocapacitor, and any other type of capacitor) or a capacitor network. The energy storage capacitor (330) is used to store electrical charge (e.g., electrical charge from the power supply (110)) and deliver some of the stored electrical charge to the pulse load (140) during a pulse condition. The voltage across the energy storage capacitor may be referred to as ECS voltage (332). The lower terminal of the energy storage capacitor (330) may be connected to terminal B (134), which may itself be connected to a ground node or a negative supply.

In one or more embodiments of the invention, the energy storage circuit (130) includes a bi-directional DC-DC converter (320). The bi-directional DC-DC converter (320) may be abstracted as an indictor (399), two switches (SW1, SW2) controlled by a single-pull double-throw (SPDT) logic block (322), and a comparator (398) feeding the SPDT logic block (322). SW 1 connects the energy storage capacitor (330) through the inductor (399) to terminal A (132) and SW 2 connects terminal B (134) to a node between the inductor and SW 1.

In one or more embodiments of the invention, when SW1 is closed (and SW2 is open), there exists a path from the energy storage capacitor (330) to the pulse load (140). In other words, when SW1 is closed (and SW2 is open), energy storage capacitor (330) is providing current to the pulse load. The current provided by the energy storage capacitor (330) supplements (i.e., is in addition to) the current being provided by the power source (110). Both the current provided by the energy storage capacitor (330) and the source current are used/needed to meet the high current (148) demands of the pulse load (140). A more efficient way to transfer charge may include periodically repeating the following set of operations: first closing SW 1, allowing current to build up in the inductor, and then closing SW 2 while opening SW 1; allowing the inductor to draw current from terminal B (134) (e.g., ground) and thus boosting the efficiency.

In one or more embodiments of the invention, operation of the switches is also used to store charge in the energy storage capacitor (i.e., store a portion of the source current from the power supply (110) in the energy storage capacitor while the pulse condition is not present). Specifically, by closing SW 2 (while SW 1 is open), allowing current to build up in the inductor (399), and then closing SW 1 and while opening SW 2, the built-up current in the inductor (399) flows into the energy storage capacitor (330) and charges the energy storage capacitor (330) to a higher voltage than the input voltage (142). This process may be repeated periodically to obtain the final value of the ESC voltage (332). In fact the bidirectional DC-DC converter (320) is configured to boost the input voltage (142) to a higher voltage (e.g., 2-10 times higher than the input voltage (142)) and apply it over the energy storage capacitor (330).

In one or more embodiments of the invention, the DC-DC converter (320) includes a comparator (e.g., an analog amplifier, a digital gate, etc.) that compares the reference voltage to the feedback voltage. If there reference voltage is higher than the feedback voltage, the comparator may drive its output to a high value (e.g., to the input voltage (142)). Conversely, if the reference voltage is smaller than the feedback voltage, the comparator may drive its output to a low value (e.g., ground). The output of the comparator is used to control the SPDT logic (322), and thus control when SW 1 and SW 2 are closed and opened.

In one or more embodiments of the invention, the VRI circuit (310) is configured to provide a feedback voltage that depends on the input voltage (142) and/or the ESC voltage (332). The feedback voltage is used to control SPDT logic block (322) and thus control whether the energy storage circuit (130) delivers current (i.e., a portion of the source current of the power supply (110)) into the energy storage capacitor (330) or whether the energy storage circuit (130) draws current from the energy storage capacitor (330) to supply the pulse load (140). In one or more embodiments of the invention, the VRI circuit (310) may include any combination of electrical components (e.g., resistors, capacitors, inductors, switches, transistors, diodes, logic gates, integrated circuits, etc.).

In one or more embodiments of the invention, the feedback voltage depends directly on the input voltage (142) and inversely on the ESC voltage (332). For example, if the input voltage (142) is increased and the ESC voltage (332) is kept constant, the feedback voltage increases, whereas if the input voltage (142) is kept constant and the ESC voltage (332) increases, the feedback voltage decreases.

In one or more embodiments of the invention, as current is delivered from the energy storage capacitor (330) to the pulse load (140), the input voltage (142) rises and thus the feedback voltage also rises, eventually shutting off the current path from the energy storage capacitor (330) to the pulse load (140). In contrast, in response to a drop in the input voltage (142) (i.e., input voltage (142) decreases due to pulse condition), the feedback voltage decreases, eventually activating the current path from the energy storage capacitor (330) to the pulse load (140). Those skilled in the art, having the benefit of this detailed description, will appreciate that the energy storage circuit (130) effectively forms a negative feedback path around the input voltage, preventing it from varying despite the varying current requirements of the pulse load (FIG. 1).

In one or more embodiments of the invention, the VRI circuit (310) includes a zener diode that is connected to a positive terminal of the energy storage capacitor (330). The zener diode may be connected in series to a resistor (e.g., resistor R2) which is connected to terminal B (134). The node in between the zener diode and R2 may be connected to the base of a bipolar junction transistor (BJT). Those skilled in the art will appreciate that the voltage at the base of the BJT equals the ESC voltage (332) minus the voltage across the zener diode.

In one or more embodiments of the invention, the collector of the BJT is connected to a resistor (e.g., R1) which is connected to Terminal A (132) and the emitter of the BJT is connector to another resistor (e.g., R3) which is connected to terminal B (134). Those skilled in the art will appreciate that the base-emitter voltage of a BJT may be approximately 0.6V-0.8V and thus the voltage drop across R3 may be approximately equal to the ESC voltage (332) minus the voltage across the zener diode minus the base-emitter voltage.

In one or more embodiments of the invention, the current flowing through the BJT fixes the voltage at the collector of the BJT (i.e., the VRT circuit attempts to keep the collector terminal at a fixed voltage making it a fixed voltage node). For example, if R4 and/or R5 are relatively large compared to R3, then nearly all of the current passing through the BJT also passes through R1, resulting in a voltage that is a fixed voltage drop less than the input voltage (142). Continuing with the previous example, suppose that the input voltage (142) is 3.9 V and R1 has a resistance of 1 kΩ, then the drop across R1 is 1 mA*1 kΩ=1 V, resulting in a voltage of 3.9 V−1 V=2.9V at the collector of the BJT.

In one or more embodiments of the invention, R4 and R5 form a voltage divider that produces the feedback voltage. In other words, the feedback voltage is an attenuated version of the collector voltage by a constant factor. For example, if R4 has a resistance of 10 kΩ and R5 also has a resistance of 10 kΩ, the feedback voltage is 2.9 V times R4/(R4+R5)=0.5, which yields a feedback voltage of 1.45V.

Recall that the feedback voltage, and therefore the charging direction of the bidirectional DC-DC converter (320), is directly proportional the input voltage (142) and inversely proportional to the ESC voltage (332). Those skilled in the art, having the benefit of this detailed description, will appreciate that when the input voltage (142) is low and the ESC voltage (332) is high, the energy storage circuit (130) will deliver current to the pulse load (FIG. 1, 140) whereas in the opposite case, when the input voltage (142) is high and the ESC voltage (332) is low, current will be delivered to the energy storage circuit (130) from the power load (FIG. 1, 110). In one or more embodiments of the invention, there exists third state in which the energy storage circuit (130) neither draws current from the power supply (FIG. 1, 110) nor delivers current to the pulse load (FIG. 1, 140).

FIG. 4 shows an energy storage circuit (400) connected to a pulse load (440) in accordance with one or more embodiments of the invention. The pulse load (440) may be essentially the same as the pulse load (140), discussed above in reference to FIG. 1. The energy storage circuit (400) may be essentially the same as the energy storage circuit (130), discussed above in reference to FIG. 1. The energy storage circuit (400) includes a buck power stage (405) and a boost power stage (410). The buck power stage (405) and a boost power stage (410) correspond to a bidirectional DC-to-DC converter. Each of the buck power stage (405) and the boost power stage (410) correspond to a unidirectional power converter. The unidirectional power converters are integrated using a synchronous switching regulator.

FIG. 5 shows an energy storage circuit (500) connected to a pulse load (540). The energy storage circuit (500) may be essentially the same as the energy storage circuit (130) discussed above in reference to FIG. 1. As shown in FIG. 5, the energy storage circuit (500) includes energy storage capacitor (520) and current bidirectional buck-boost power stage (510). The energy storage capacitor (520) may correspond to the energy storage capacitor (330) discussed above in reference to FIG. 3. Similarly, the current bidirectional buck-boost power stage (510) may correspond to the bidirectional DC-DC converter (320), discussed above in reference to FIG. 3. The current bidirectional buck-boost power stage is configured to charge the energy storage capacitor to a voltage greater than the source voltage while the pulse condition is not present.

FIG. 6 depicts a flowchart of a method for operating an energy storage (ES) circuit. In one or more embodiments of the invention, one or more of the steps shown in FIG. 6 may be omitted, substituted, repeated, and/or performed in a different order. Accordingly, embodiments of the invention should not be considered limited to the specific arrangements of steps shown in FIG. 6. In one or more embodiments, the method described in reference to FIG. 6 may be practiced using the system (100) and the energy storage circuit (130) described in reference to FIG. 1 and FIG. 3 above.

Initially in step 602, an energy storage circuit (ESC) draws charge from a source current provided by a power supply and connected to a pulse load. This takes place while a pulse condition is not present and the low current being drawn by the pulse load is less than the source current being provided by the power supply. The energy storage circuit may draw charge in response to the input voltage across the pulse load being sufficiently high.

In step 604, the portion of the source current being drawn by the ESC is used to recharge an energy storage capacitor within the ESC. The ESC may include a first route the current through a DC-DC converter to boost the voltage of the energy storage capacitor above a source voltage of the power supply, thereby storing more energy per capacitance of the energy storage capacitor, as discussed above in reference to FIG. 3.

In steps 606 and 608, the ESC detects a voltage drop at the input of the pulse load. The drop may be the result of a pulse condition (i.e., high current requirement) pushing the power supply well past the current limit. The ESC may include a circuit that takes the input voltage of the pulse load as input and converts it to a feedback voltage. In one or more embodiments of the invention, the feedback voltage may also depend on the voltage of the energy storage capacitor. In one or more embodiments of the invention, the feedback voltage is directly proportional to the input voltage and inversely proportional to the voltage of the energy storage capacitor. Since the input voltage drops, the feedback voltage may also drop. The drop in feedback voltage may control/instruct the DC-DC converter to begin drawing current from the energy storage capacitor and supplying it to the pulse load to satisfy the high current requirements of the pulse load (140) during the pulse condition. This reduces the burden on the power supply during the pulse condition.

In step 610, based on a reduction in the feedback voltage, the ESC delivers current from the energy storage capacitor to the pulse load, thereby reducing the voltage drop in the pulse load. Those skilled in the art will appreciate that the feedback voltage will rise as the input voltage drop decreases, eventually shutting off the current path from the energy storage capacitor to the pulse load, and thus settling on a stable value for the input voltage. The process shown in FIG. 6 may be repeated any number of times.

Embodiments of the invention may have one or more advantages of the invention: the ability to increase the power available, from a peak current limited power supply, to a pulse current type of load; the ability to use a greater percentage of the continuous output current rating and cost to be applied to the pulse current load application; the ability to use one circuit for the energy storage circuit; the ability to eliminate the delay due to the operating point slew from off to operating bias as the control loop in always in the biased condition; the ability to reduce the power supply power rating from the peak load power to the average power of the load (e.g., a power supply providing power to a pulse load with 25% duty cycle could have its rating reduced by a factor of four which would reduce cost and space, an existing power supply could support a 25% duty cycle pulse load with a pulse power four times its average power rating).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An energy storage (ES) circuit, comprising:
a plurality of terminals configured to:
connect to a pulse load having an input voltage and drawing a low current during a first interval and a high current during a second interval; and
connect to a power supply having a source voltage and delivering a source current;
an energy storage capacitor operatively connected to the plurality of terminals; and
a bidirectional direct current (DC) to DC converter configured to:
recharge, during at least a portion of the first interval, the energy storage capacitor using a plurality of charge drawn from the source current; and
reduce a drop in the input voltage during the second interval by delivering a difference between the source current and the high current to the pulse load using the plurality of charge stored in the energy storage capacitor.

2. The ES circuit of claim 1, wherein the drop is based on current limiting of the power supply.

3. The ES circuit of claim 1, wherein the drop is based on the high current and a distribution impedance of a conductor operatively connecting the power supply to one of the plurality of terminals.

4. The ES circuit of claim 1, wherein the bidirectional DC to DC converter comprises:
a synchronous switching regulator; and
a plurality of separate unidirectional power converters integrated using the synchronous switching regulator.

5. The ES circuit of claim 1, further comprising:
a voltage regulation interface (VRI) circuit configured to control, based on the input voltage to the pulse load, a feedback voltage applied to the bidirectional DC to DC converter,
wherein the bidirectional DC to DC converter delivers the difference based on the feedback voltage.

6. The ES circuit of claim 5, wherein the VRI circuit comprises:
a bipolar junction transistor (BJT) comprising a base, a collector, and an emitter;
a zener diode connected to the base of the BJT and the energy storage capacitor; and
a resistor connected to the collector of the BJT and a terminal of the plurality of terminals.

7. The ES circuit of claim 5, wherein the bidirectional DC to DC converter comprises:
a current bidirectional buck-boost power stage to charge the energy storage capacitor to a voltage greater than the source voltage during the first interval.

8. The ES circuit of claim 5, wherein the power supply reduces the source current during the first interval after the energy storage capacitor is fully charged.

9. The ES circuit of claim 5, wherein the energy storage capacitor comprises a first capacitor in parallel with a second capacitor.

10. The ES of claim 1, wherein the power supply has a continuous output current rating, and wherein having the source current present during the second interval and during the portion of the first interval allows a greater percentage of the continuous output current rating to be applied to the pulse load.

11. A method for operating an energy storage (ES) circuit comprising an energy storage capacitor and a plurality of terminals, the method comprising:
drawing, by the ES circuit, a plurality of charge from a source current delivered by a power supply having a source voltage,
wherein the plurality of terminals connect to the power supply and to a pulse load having an input voltage and drawing a low current during a first interval and a high current during a second interval;
recharging, during at least a portion of the first interval and by a bidirectional direct current (DC) to DC converter of the ES circuit, the energy storage capacitor using the plurality of charge; and
reducing, by the ES circuit, a drop in the input voltage during the second interval by delivering a difference between the source current and the high current to the pulse load using the plurality of charge stored in the energy storage capacitor.

12. The method of claim 11, wherein the drop is based on current limiting of the power supply.

13. The method of claim 11, wherein the drop is based on the high current and a distribution impedance of a conductor operatively connecting the power supply to one of the plurality of terminals.

14. The method of claim 11, wherein the power supply reduces the source current during the first interval after the energy storage capacitor is fully charged.

15. The method of claim 11, wherein the energy storage capacitor comprises a first capacitor in parallel with a second capacitor.

16. The method of claim 15, further comprising:
controlling, by a voltage regulation interface (VRI) circuit of the ES circuit, a feedback voltage applied to the bidirectional DC to DC converter based on the input voltage to the pulse load,
wherein the bidirectional DC to DC converter delivers the difference based on the feedback voltage.

17. The method of claim 16, wherein the VRI circuit comprises:
a bipolar junction transistor (BJT) comprising a base, a collector, and an emitter;
a zener diode connected to the base of the BJT and the energy storage capacitor; and
a resistor connected to the collector of the BJT and a terminal of the plurality of terminals.

18. The method of claim 16, wherein recharging the energy storage capacitor comprises:
boosting, by the bidirectional DC to DC converter, a voltage at a terminal of the ES circuit to charge the energy storage capacitor to a voltage greater than the source voltage.

19. The method of claim 11, wherein the DC to DC converter comprises:
a synchronous switching regulator; and
a plurality of separate unidirectional power converters integrated using the synchronous switching regulator.

20. The method of claim 11, wherein the power supply has a continuous output current rating, and wherein having the source current present during the second interval and during the portion of the first interval allows a greater percentage of the continuous output current rating to be applied to the pulse load.
